(19) United States
(12) Patent Application Publication
(10) Pub. No.: US 2005/0220292 A1
(43) Pub. Date: Oct. 6, 2005

(54) Method of discriminating between double-talk state and single-talk state

(75) Inventors: Hiraku Okumura, Hamamatsu (JP); Toru Hirai, Hamamatsu (JP)

Correspondence Address: PILLSBURY WINTHROP SHAW PITTMAN LLP, 725 S. FIGUEROA STREET, SUITE 2800, LOS ANGELES, CA, 90017, US

(73) Assignee: Yamaha Corporation, Hamamatsu-shi (JP)

(21) Appl. No.: 11/093,800

(22) Filed: Mar. 30, 2005

(30) Foreign Application Priority Data
Mar. 31, 2004 (JP) 2004-102253
Jan. 2, 2005 (JP) 2005-024701

(51) Int. Cl. H04M 9/08

(52) U.S. Cl. 379/406.12; 379/406.11

(57) ABSTRACT

An apparatus is designed for processing a first audio signal at transmission and a second audio signal upon receipt so as to determine whether the second audio signal is provided under a double-talk state or a single-talk state. In the apparatus, a storage section stores the first audio signal. A convolution section convolutes the stored first audio signal with a variable coefficient to produce a reference signal. The variable coefficient is updated by an update addition value. A subtraction section subtracts the reference signal from the second audio signal to provide an error signal. A computation section computes the update addition value for the variable coefficient on the basis of the error signal and the first audio signal. A determination section determines whether the second audio signal is provided under the double-talk state or the single-talk state on the basis of the update addition value.

### BACKGROUND OF THE INVENTION

1. Technical Field

The present invention relates to a double-talk state determination method, an echo cancellation method, a double-talk state determination apparatus, an echo cancellation apparatus and a program, which are suitable for use in hands-free talking through a two-way voice communication system.

2. Related Art

Echo cancellers (or echo suppressors) are used in reducing acoustic echoes that are generated in hands-free talking by use of a microphone/speaker at a remote party of the two-way voice communication system. An output signal from the speaker is affected by the echo path between speaker and microphone, such as the reflection from walls and doors for example, before being picked up by the microphone, so that the microphone output signal contains an acoustic echo signal caused by such a speaker output. Therefore, the acoustic echo signal can be canceled by subtracting a pseudo echo signal from the microphone output signal. The pseudo echo signal is obtained by convoluting a filtering coefficient into the speaker output signal. The filtering coefficient is obtained by simulating this echo path by an adaptive filter.

A technique is known in which parameters for generating the pseudo echo signal are recurrently updated such that a differential signal (or an error signal) between an actual echo signal and the pseudo echo signal obtained by simulating the echo signal caused by the speaker output signal is minimized.

However, an actual microphone output signal includes not only the acoustic echo signal caused by speaker output but also voice and dark noise that are directly inputted in the microphone. A state in which both the echo sound from the speaker and other sound are generated at the same time in a room is called a double-talk state.

The echo canceller using the adaptive filter updates the filter coefficient such that, on the basis of a reference signal (normally, a speaker input signal) and an error signal, an echo component contained in the error signal and highly correlated with the reference signal is canceled. Therefore, if the adaptive filter is properly operating, the error signal is reduced. However, if a change occurs in the echo path between the speaker and the microphone, the adaptive filter follows the change, so that an update amount of the filtering coefficient increases accordingly.

The error signal is also enlarged in the double-talk state described above. Accordingly, the update amount of the adaptive filter also increases. However, the error signal enlarged by the double talk has no relation to the echo path between the speaker and the microphone, hence the echo path cannot be properly estimated from the error signal provided under the double-talk state as a consequence. In the double-talk state, the error signal is quickly enlarged, so that the updating of the parameters must be stopped.

For this purpose, a technique is disclosed (refer to patent document 1 below) in which the double-talk state is detected by comparison between an audio signal power before imparting of an acoustic echo and an error signal power so as to stop the updating of parameters if the double-talk state is detected.

In addition, another technique is disclosed (refer to patent document 2 below) in which the upper and lower limits are provided to a correction factor in parameter updating and, if the correction factor falls out of the range between these limits, the upper limit or the lower limit is regarded as the correction factor, thereby restricting an excessive response to the double talk.

Further, a technique is disclosed (refer to patent document 3 below) in which a comparison is made between the residual powers in the preceding and succeeding stages of impulse response and, if the residual power in the succeeding stage is found greater, the double-talk state is determined, thereby stopping the updating of parameters.
[Patent document 1] Japanese Published Unexamined Patent Application No. 2000-252884
[Patent document 2] Japanese Published Unexampled Patent Application No. Hei 10-303787
[Patent document 3] Japanese Published Unexamined Patent Application No. Hei 4-127721

With the technique disclosed in patent document 1 above, determination of the double-talk state is made on the basis of the magnitude of an error signal, so that it is difficult to judge whether the error signal has been enlarged due to the variation in echo path or due to the occurrence of double talk, thereby inadvertently executing the updating that is unnecessary under normal conditions. With the technique disclosed in patent document 2 above, the correction factor of parameters is restricted, so that the response of the adaptive filter to the change in echo path is delayed, thereby making it difficult to provide quick learning of the change of the echo path. With the technique disclosed in patent document 3 above, the power of the succeeding stage of impulse response is increased in case that the echo path is long, so that double talk might be erroneously detected.

### SUMMARY OF THE INVETNION

It is therefore an object of the present invention to provide a double-talk state determination method, a double-talk state determination apparatus, and a program for determining the double-talk state on the basis of update coefficient values with high accuracy of determination. It is another object of the invention to provide an echo cancellation method, an echo cancellation apparatus and, a program for preventing the increase in the estimation error in an echo path while removing the effects of the variations in the double-talk state.

In one aspect of the invention, a method is designed for processing a first audio signal at transmission and a second audio signal upon receipt so as to determine whether the second audio signal is provided under a double-talk state or a single-talk state. The inventive method comprises a first transform step of transforming the first audio signal of time domain into a first signal of frequency domain composed of a plurality of frequency components each having an amplitude and a phase of specific values, a multiplication step of multiplying each frequency component of the first signal by a variable coefficient to produce a reference signal of frequency domain, the variable coefficient being updated by an update addition value, a second transform step of transforming the second audio signal of time domain into a second signal of frequency domain composed of a plurality of frequency components each having an amplitude and a phase of specific values, a subtraction step of subtracting the reference signal from the second signal to provide an error signal of frequency domain, a computation step of computing the update addition value for the variable coefficient on the basis of the error signal and the first signal, and a determination step of determining whether the second audio signal is provided under the double-talk state or the single-talk state on the basis of the update addition value.

Alternatively, there is provided an inventive method of processing a first audio signal at transmission and a second audio signal upon receipt so as to determine whether the second audio signal is provided under a double-talk state or a single-talk state. The inventive the method comprises a storage step of storing the first audio signal, a convolution step of convoluting the stored first audio signal with a variable coefficient to produce a reference signal, the variable coefficient being updated by an update addition value, a subtraction step of subtracting the reference signal from the second audio signal to provide an error signal, a computation step of computing the update addition value for the variable coefficient on the basis of the error signal and the first audio signal, and a determination step of determining whether the second audio signal is provided under the double-talk state or the single-talk state on the basis of the update addition value.

Preferably, the determination step compares the update addition value with a predetermined upper critical value and determines that the second audio signal is provided under the double-talk state when the update addition value exceeds the predetermined upper critical value. Also, the determination step compares the update addition value with a predetermined lower critical value and determines that the second audio signal is provided under the single-talk state when the update addition value is lower than the predetermined lower critical value. Further, the determination step compares a current update addition value with a previous update addition value and determines that the second audio signal is currently provided under the double-talk state when a difference between the current update addition value and the previous update addition value is greater than a predetermined threshold value. Otherwise, the determination step determines that the second audio signal is currently provided under the single-talk state when the difference between the current update addition value and the previous update addition value is smaller than the predetermined threshold value and when the variable coefficient has not been updated by the previous update addition value.

In another aspect of the invention, there is provided a method of canceling an echo of a first audio signal which is transmitted to a remote place, from a second audio signal which is received from the remote place and contains the echo, the second audio signal being provided under either of a double-talk state or a single-talk state. The inventive method comprises a first transform step of transforming the first audio signal of time domain into a first signal of frequency domain composed of a plurality of frequency components each having an amplitude and a phase of specific values, a multiplication step of multiplying each frequency component of the first signal by a variable coefficient to produce a reference signal of frequency domain, the variable coefficient being updated by an update addition value, a second transform step of transforming the second audio signal of time domain into a second signal of frequency domain composed of a plurality of frequency components each having an amplitude and a phase of specific values, a subtraction step of subtracting the reference signal from the second signal to provide an error signal of frequency domain, whereby the echo contained in the second audio signal can be canceled by the subtracting step, a computation step of computing the update addition value for the variable coefficient on the basis of the error signal and the first signal, a determination step of determining whether the second audio signal is provided under the double-talk state or the single-talk state on the basis of the update addition value, and an update step of updating the variable coefficient by the update addition value when the determination step determines that the second audio signal is provided under the single-talk state, and stopping the updating of the variable coefficient by the update addition value when the determination step determines that the second audio signal is provided under the double-talk state.

Alternatively, an inventive method is designed for canceling an echo of a first audio signal which is transmitted to a remote place, from a second audio signal which is received from the remote place and contains the echo, the second audio signal being provided under either of a double-talk state or a single-talk state. The inventive method comprises a storage step of storing the first audio signal, a convolution step of convoluting the stored first audio signal with a variable coefficient to produce a reference signal, the variable coefficient being updated by an update addition value, a subtraction step of subtracting the reference signal from the second audio signal to provide an error signal, whereby the echo can be canceled from the second audio signal, a computation step of computing the update addition value for the variable coefficient on the basis of the error signal and the first audio signal, a determination step of determining whether the second audio signal is provided under the double-talk state or the single-talk state on the basis of the update addition value, and an update step of updating the variable coefficient by the update addition value when the determination step determines that the second audio signal is provided under the single-talk state, and stopping the updating of the variable coefficient by the update addition value when the determination step determines that the second audio signal is provided under the double-talk state.

According to the novel configuration of the present invention, the double-talk state and the single-talk state are discriminated on the basis of update addition values, so that it is correctly determined as to whether or not the echo canceling coefficient should be updated.

### BRIEF DESCRIPTION OF THE DRAWINGS

FIG. 1 is a hardware configuration diagram of an echo cancellation apparatus using a double-talk determination apparatus practiced as a first embodiment of the invention.

FIG. 2 is an algorithm configuration diagram (in the frequency domain) of the echo cancellation apparatus including the double-talk state determination apparatus shown in FIG. 1.

FIG. 3 is a flowchart showing operation of the first embodiment in the frequency domain.

FIGS. 4(a) and 4(b) are diagrams illustrating response characteristics obtained when transition occurs from the single-talk state to the double-talk state and a quick change in echo path occurs.

FIG. 5 is an algorithm configuration diagram (in time domain) of an echo cancellation apparatus including a double-talk state determination apparatus practiced as a second embodiment of the invention.

FIG. 6 is a flowchart showing operation of the second embodiment in the time domain.

### DETAILED DESCRIPTION OF THE INVENTION

### 1. First Embodiment

1.1 Configuration of Embodiment

1.1.1 Hardware Configuration

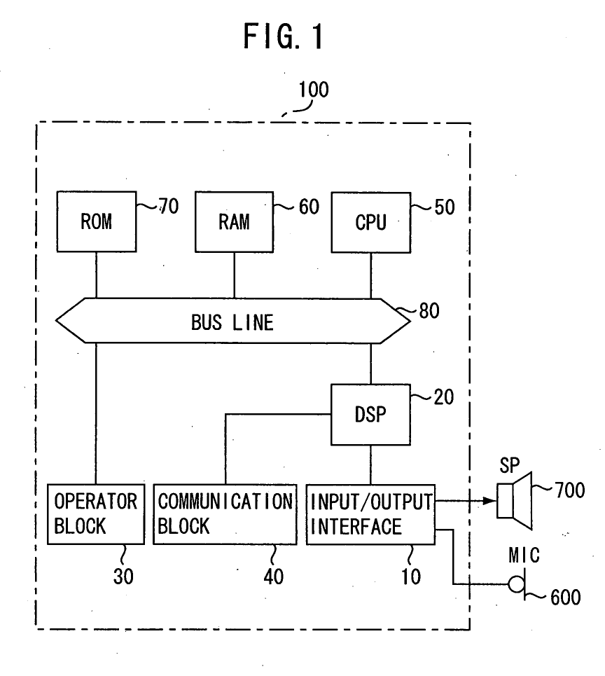

The following describes a hardware configuration of an echo cancellation apparatus (or a double-talk state determination apparatus) practiced as a first embodiment of the invention, with reference to FIG. 1.

In FIG. 1, reference numeral 10 denotes an input/output interface based on an A/D converter and a D/A converter. The A/C converter converts an analog audio signal into a digital audio signal. The D/A converter converts a digital audio signal into an analog audio signal. A microphone 600 and a loudspeaker 700 are connected to the input/output interface 10. Reference numeral 20 denotes a DSP that digitally processes the audio signal captured through the input/output interface 10. The audio signal processed by the DSP 20 is outputted through the input/output interface 10. Reference numeral 30 denotes an Operator block made up of switches, volumes, and other controls. Reference numeral 40 denotes a communication block that assumes communication of the echo cancellation apparatus with a remote party. Reference numeral 50 denotes a CPU that controls the other components of the echo cancellation apparatus. Reference numeral 60 denotes a RAM that is used as a work memory. Reference numeral 70 denotes a ROM that stores programs and parameters. The programs includes an inventive program executable by the CPU 50 for carrying out the inventive method of determining the double-talk state and canceling the echo. Reference numeral 80 denotes a bus lines that interconnects the other components. These components make up the echo cancellation apparatus (or an echo canceller or a double-talk state determination apparatus) 100.

1.1.2 Configuration of Algorithm

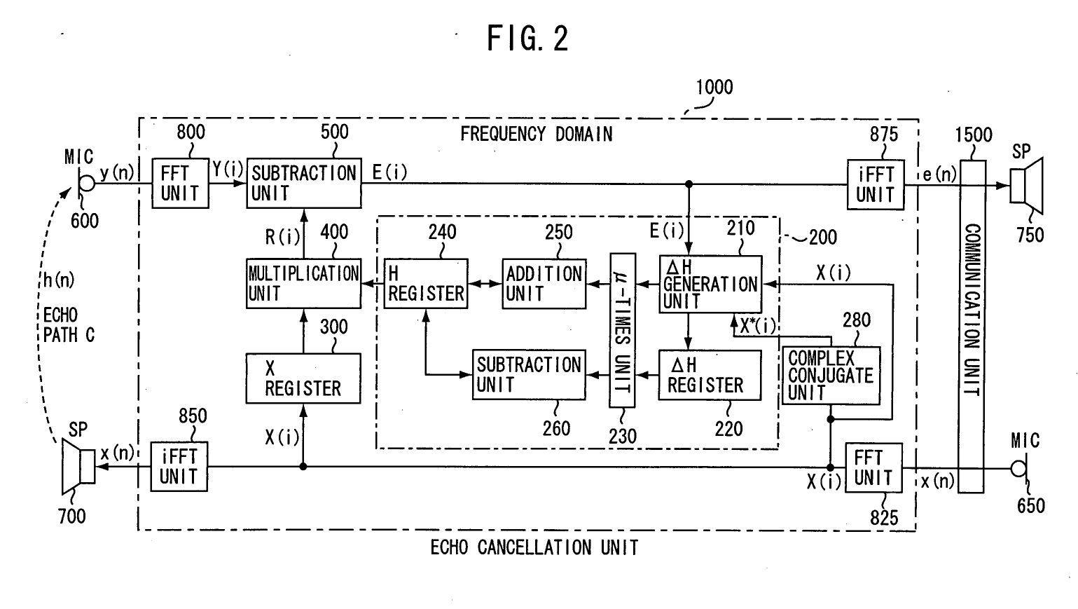

An audio signal picked up by the microphone of the other party goes through the communication block 40, the DSP 20, and the input/output interface 10 to be sounded from the loudspeaker 700. An audio signal picked up the microphone 600 is sounded from the loudspeaker of the other party through an input/output interface 10, the DSP 20, and the communication block 40. This processing is executed by the CPU 50 and the DSP 20 in software approach. The following describes an algorithm configuration of the echo cancellation apparatus 100 with reference to FIG. 2. It should be noted that, in the first embodiment, the signal processing in the frequency domain will be described.

In the figure, reference numeral 560 denotes a microphone of the other party, which converts voice into an electrical signal. Reference numeral 750 denotes the loudspeaker of the other party, which converts an analog audio signal into a mechanical vibration to output sound. Reference numeral 1500 denotes a communication unit that receives an audio signal from the microphone of the other party and transmits the received audio signal to the loudspeaker 750 of the other party. At this moment, the received analog audio signal is sampled at a constant time interval and the sampled signal is outputted by the communication unit 1500 as digital audio signal x(n). Reference numeral 700 denotes the loudspeaker through which an audio signal picked up by the microphone 650 is sounded through a FFT unit and an iFFT unit to be described later. In addition, the sound outputted from the loudspeaker 700 is reflected from walls and doors and the reflected sound is picked up by the microphone 600. The signal derived from the loudspeaker 700 and detected by the microphone 600 is referred to as an acoustic echo and a path between the loudspeaker 700 and the microphone 600 is referred to echo path C. Further, the signal picked up by the microphone 600 is sampled at a constant time interval and the sample signal is outputted as digital audio signal y(n).

Reference numerals 800 and 825 denote FFT units for executing, every predetermined-length frame, discrete Fourier transform on digital audio signal x(n) (or y(n)) picked up the microphone 600 or the microphone 650. Consequently, as a function of discrete frequency i, discrete Fourier transform X(i) or (Y(i)) is computed. Namely, discrete Fourier transform X(i) is complex data about digital audio signal x(n) and a signal in the frequency domain for specifying the amplitude and phase of a plurality of frequency components.

It should be noted that, as known, output signal y(n) obtained from digital audio signal through echo path C is computed by convoluting audio signal x(n) and impulse response h(n) of echo path C. Hence, Fourier transform Y(i) of output signal y(n) is expressed in a multiplication between Fourier transform H(i) of impulse response h(n) and Fourier transform X(i) of audio signal x(t) as shown in equation (1) below:
Y(i)=H(i)·X(i) (1)
where signals sampled in the time domain are represented by lower cases of variable n, namely, x(n), y(n), and h(n) for example and the discrete Fourier transforms converted into the frequency domain are represented by upper cases of variable i, namely, X(i), Y(i), and H(i) for example. This means that upper case letters represent complex number signals.

Reference numerals 850 and 875 are iFFT units for executing inverse Fourier transform on discrete Fourier transform X(i) or error signal E(i) to be described later to get signal x(n) or e(n) in the time domain. Reference numeral 300 denotes an X register capable of storing N complex number signals of Fourier transform X(i). At the same time the voice of Fourier transform X(i) is sounded from the loudspeaker 700, Fourier transform X(i) is stored in an X register 300.

Reference numeral 400 denotes a multiplication unit for executing the multiplication in equation (2) below to generate the complex data of reference signal R(i):
R=(i)=Hₖ(i)·X(i) (2)
where Hₖ(i) is an estimated transmission function for Fourier X(i) in k-th frame update, which is updated so as to gradually approximate transmission function H(i) of echo path C by the processing to be described later. Namely, reference signal R(i) is obtained by multiplication between estimated transmission function Hₖ(i) and Fourier transform X(i). Reference numeral 500 denotes a subtraction unit for subtracting a value of reference signal R(i) from a value of Fourier transform Y(i) in both real and imaginary parts, obtaining error signal E(i). Error signal E(i) is transformed as follows:

$$\begin{matrix}E ( i ) = Y ( i ) - R ( i ) \\ = H ( i ) \cdot X ( i ) - {H}_{k} ( i ) \cdot X ( i ) \\ = \{ H ( i ) - {H}_{k} ( i ) \} \cdot X ( i ) \\ = Δ {H}_{k} ( i ) \cdot X ( i ) \cdot X ( i )\end{matrix}$$
where ΔHₖ(i)=H(i)−Hₖ(i). It should be noted that ΔHₖ(i) is called an update addition value, which is a difference in updating estimated transmission function Hₖ(i).

Then, audio signal e(n) obtained by executing inverse Fourier transform on error signal E(i) is sound from the loudspeaker 750 of the other party through the iFFT unit 850 the communication unit 1500.

A reference numeral 280 is a complex conjugate unit for generating complex conjugate X*(i) of Fourier transform X(i). Reference numeral 210 denotes a ΔH generation unit for computing a value of update addition value ΔHₖ(i) by use of a value of error signal E(i) and a value of complex conjugate X*(i).

$$\begin{matrix}E ( i ) \cdot X * ( i ) = Δ {H}_{k} ( i ) \cdot X ( i ) \cdot X * ( i ) \\ = Δ {H}_{k} ( i ) \cdot {\vert X ( i ) \vert}^{2} \\ Δ {H}_{k} ( i ) = E ( i ) \cdot X * ( i ) / {\vert X ( i ) \vert}^{2}\end{matrix} \qquad ( 3 )$$

Namely, error signal E(i) is multiplied by complex conjugate X*(i) of Fourier transform X(i) and an obtained value is divided by the power of audio signal X(i) provides update addition value ΔHₖ(i).

Reference numeral 220 denotes a ΔH register for temporarily storing a complex number value computed by the ΔH generation unit 210. Reference numeral 230 denotes a μ-times unit for multiplying an output value of the ΔH generation unit 210 by a value of convergent coefficient μ as required. Moreover, the μ-times unit 230 multiplies an output value of ΔH register 220 by a value of μ. Reference numeral 240 denotes an H register for storing a complex number value of estimated transmission function Hₖ(i). Reference numeral 250 denotes an addition unit for adding an output value of the ΔH generation unit 210 times by μ to a value of the H register 240. Reference numeral 260 denotes a subtraction unit for subtracting an output value of ΔH register 220 timed by μ from a value of the H register 240. An adaptive filter 200 is made up of the ΔH generation unit 210, ΔH register 220, the μ-times unit 230, the H register 240, the addition unit 250, and the subtraction unit 260. An echo cancellation unit 1000 is made up of the X register 300, the multiplication unit 400, the subtraction unit 500, and the adaptive filter 200.

1.2 Operation of the First Embodiment

1.2.1 Overall Operation of the Echo Cancellation Apparatus 100

As described above, when sampled audio signal x(n) sampled after being picked up by the microphone 650 of the other part is sounded from the loudspeaker 700, this audio signal x(n) is convoluted by impulse response h(n) of echo path C an audio signal y(n) picked up by the microphone 600 is outputted. Removal of the acoustic echo requires the removal of audio signal x(n) from audio signal y(n) picked up by the microphone 600. However, because impulse response h(n) of echo path C and audio signal x(n) are convoluted, audio signal y(n) cannot be removed by simply by subtracting each signal. Therefore, estimated transmission function Hₖ(i) is required to approximate transmission function H(i) of each path C.

1.2.2 Operation of the Echo Cancellation Unit 1000

If a multiplication is executed by the multiplication unit 400 in a double-talk state where only audio sounded from the loudspeaker 700 is picked up by the microphone 600 via echo path C, reference data (pseudo echo) R(i) obtained by simulating the signal transmitted via echo path C is generated. At this moment, estimated transmission function Hₖ(i) is separately set by the adaptive filter 200. On the other hand, audio signal y(n) outputted from the microphone 600 is Fourier-transformed by the FFT unit 800, providing Fourier transform Y(i).

Then, the subtraction unit 500 subtracts reference signal R(i) from Fourier Transform Y(i). Further, estimated transmission function Hₖ(i) is sequentially updated so as to minimize error signal E(i) computed by the subtraction unit 500. Consequently, the filter coefficient converges to the proximity of transmission function H(i) by the increase in the value of k. Error signal E(i) is converted into an audio signal by the iFFT unit 850, the audio signal being sounded from the loudspeaker 750 of the other party via the communication unit 1500.

However, error signal E(i) includes not only the audio signal and acoustic echo from the microphone 650 but also an audio signal that is uttered by the speaker of the side of the microphone 600. In such a double-talk state, error signal E(i) increases by an amount equivalent to the audio signal component of the speaker on the side of the microphone 600. Here, the adaptive filter 200 attempts to update estimated transmission function Hₖ(i) so as to minimize error signal E(i) that is not valid, thereby causing a problem that the estimated transmission function is set to an improper value. Therefore, it becomes necessary to forcibly stop the updating of the estimated transmission function in the double-talk state.

1.2.3 Operation of the Adaptive Filter 200

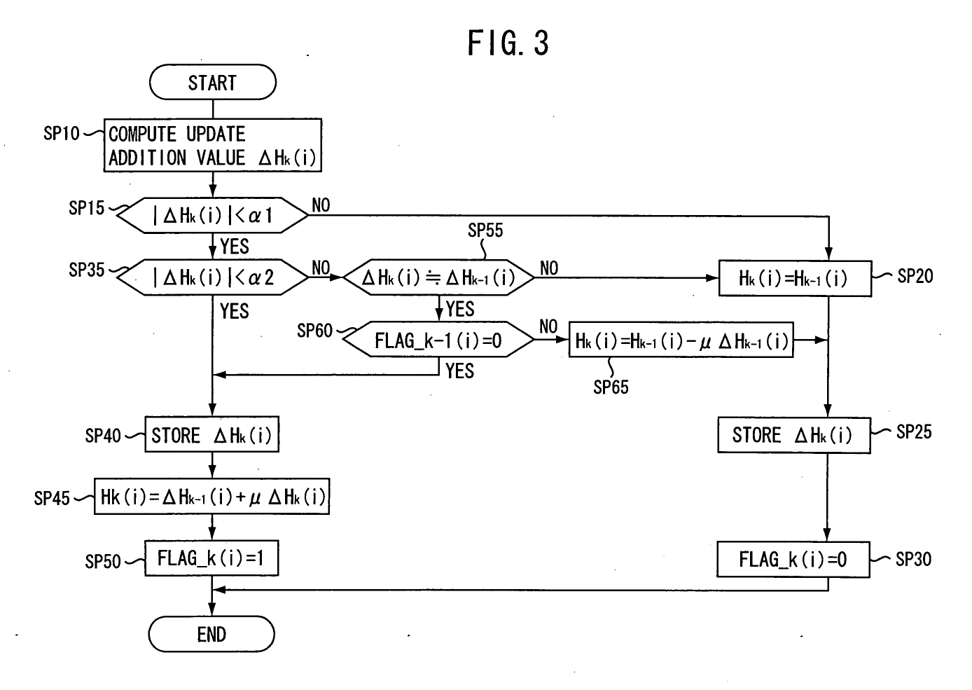

In the double-talk state, the adaptive filter 200 stops updating estimated transmission function Hₖ(i); in the single-talk state, the adaptive filter 200 updates Hₖ(i) so as to minimize error signal E(i). Therefore, a routine shown in FIG. 3 is activated for X(i) every k-th frame updating. In step SP10, update addition value ΔHₖ(i) is computed on the basis of equation (3). Then, the procedure goes to step SP15.

In step SP15, it is determined whether the absolute value of update addition value ΔHₖ(1) is smaller than the value of any setting value α1. For α1, a value that allows the determination of the double-talk state is set as a double-talk determination threshold value. If the absolute value of ΔHₖ(i) is found greater than the value of α1, then the decision is “NO”, upon which the procedure goes to step SP20. In step SP20, the value of Hₖ(i) in the H register 240 is set to Hₖ₋₁(i) and the estimated transmission function is not updated. The procedure goes to step SP25, in which the value of ΔHₖ(i) is stored in the ΔH register 220. In step SP30, the value of flag_k(i) is set to “0”, upon this routine comes to an end. Here, flag-k(i) denotes whether estimated transmission function Hₖ(i) has been updated at k-th frame, “1” denoting that the update has been made while “0” denotes that the update has not been made.

On the other hand, if the absolute value of update addition value ΔHₖ(i) is found smaller than the value of al in step SP15, then the decision is “YES”, upon which the procedure goes to step SP35. In step SP35, it is determined whether the absolute value of update addition value ΔHₖ(i) is smaller than any setting value α2. For α2, a small value that allows the determination of the single-talk state is set. If the absolute value of update addition value ΔHₖ(i) is found smaller than α2, the decision is “YES”, upon which procedure goes to step SP40. In step S40, the value of ΔHₖ(i) is stored in the ΔH register 220, upon which the procedure goes to step SP45, in which the value of estimated transmission function Hₖ(i) is updated to a value of {Hₖ₋₁(i)+μΔHₖ(i)} by the μ-times unit 230 and the addition unit 250. Here, convergence coefficient μ is selected to any value. In step SP50, the value flag_k(i) i set to “1”, storing the updating of the estimated transmission function at the k-th frame. Then, this routine comes to an end.

If the absolute value of update addition value ΔHₖ(i) is found greater than α2 in step SP35, then the decision is “NO”. In this case, one of the double-talk state and the single-talk state is possible. Then, the procedure goes to step SP55, in which it is determined whether the value of update addition value ΔHₖ(i) is approximately equal to the value of last update addition value ΔHₖ₋₁(i). The reason of executing this determination is as follows. In the present embodiment, it is assumed that the echo path be generated between the microphone and the loudspeaker. Therefore, the echo path varies depending on the door open/close operation and the range between microphone and loudspeaker, so that the temporal variation of the system is comparatively slow. Consequently, the temporal variation of ΔHₖ(i) is small, the value of ΔHₖ(i) being approximately equal to the value of ΔHₖ₋₁(i). Namely, a range (or an allowance) in which the value of ΔHₖ₋₁(i) is determined approximately equal to the value of Hₖ(i) depends not only on the sampling time in addition to the size of the room, the door open/close operation, and the range between microphone and loudspeaker. If the value of ΔHₖ₋₁(i) is found approximately equal to the value of ΔHₖ(i), then the decision is “YES”, upon which the procedure goes to step SP60. The determination “approximately equal” is made by the following criterion for example:
0.9<|ΔHₖ(i)/ΔHₖ₋₁(i)|<1.1
Namely, it is determined whether the update addition value falls in a predetermined range.

In step SP60, it is determined whether flag_k−1(i)=0. If the double-talk state was determined and flag_k−1(i)=0 was set, actually the single-talk state should have been determined because there is almost no possibility that the update addition value ΔHₖ(i) becomes equal to ΔHₖ₋₁(i) in the double-talk state. In such a case, it is assumed that the coefficient was not updated inadvertently even the condition was actually single-talk state. Thus, in order to correct this error, almost same update addition value is calculated this time. Namely, if flag_k−1=0 is held at step SP60, it indicates that an echo path variation has occurred in the single-talk state and therefore the decision is “YES”, upon which the procedure goes to step SP40, in which the coefficient is changed through steps SP45 and SP50, upon which this routine comes to an end.

If flag_k−1(i)=1 in step S60, it indicates that the update was made at the last time (k−1) and therefore the decision is “NO”. Namely, even in the double-talk state, the coefficient was inadvertently updatred, upon which the procedure goes to step SP65. In step SP65, the value of {Hₖ₋₁(i)−μΔHₖ₋₁(i)} is set to the value of estimated transmission function Hₖ(i). Namely, the update at the last time (k−1) is invalidated. This invalidation deteriorates the echo cancellation efficiency but prevents the disturbance of the estimated transmission function arising from the double-talk state. Then, the procedure goes to step SP25 to step SP30 to end this routine.

If the value of ΔHₖ(i) is significantly different from the value of ΔHₖ₋₁(i) in step SP55, it indicates the double-stalk state, upon which the procedure goes to step SP20. This routines ends through steps SP25 and SP30.

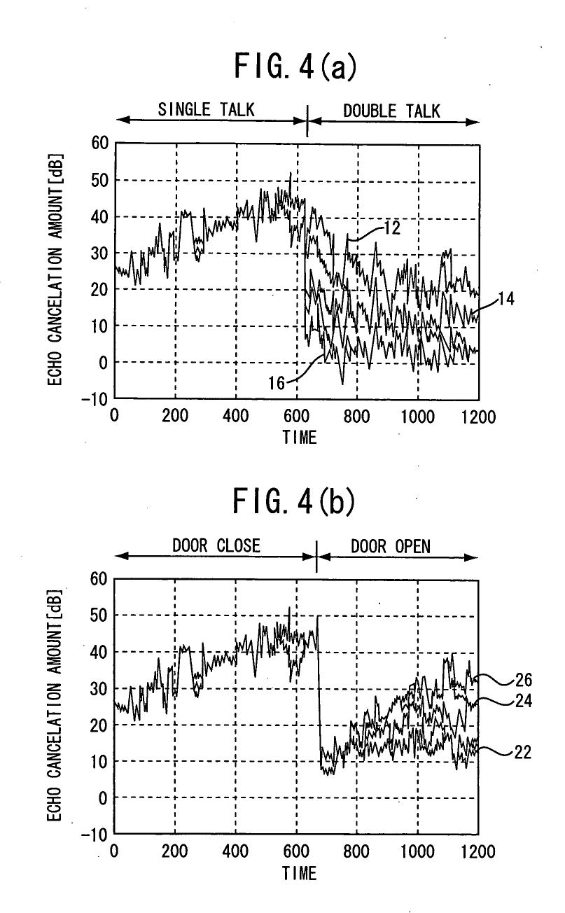

FIGS. 4(a) and 4(b) show the characteristics of echo cancellation volume obtained by executing adaptive control in the frequency domain. In each figure, the vertical axis represents echo cancellation volume (in dB) and the horizontal axis represents response time. FIG. 4(a) shows the response characteristic obtained when transition occurred from the single-talk state to the double-talk state. Lines 12 are indicative that double-talk determination threshold value α1=0.01. Lines 14 are indicative that α1=0.03. Lines 16 are indicative of α1=0.1. When α1=0.01, double talk is detected and the coefficient is not updated. Hence, no improper coefficient updating in the double-talk state is not executed, resulting in no lowered echo cancellation efficiency. On the other than, when α1=0.1, double talk is not detected and the improper coefficient updating in the double-talk state is executed, resulting in a significantly lowered echo cancellation efficiency. FIG. 4(b) shows the response characteristic obtained when transition occurs from door close status to door open status, in which the echo path quickly varies. Lines 22 are indicative that double-talk determination threshold value α1=0.01. Lines 24 are indicative that α1=0.03. Lines 26 are indicative that α1=0.1. When α1=0.01, the variation in echo path is not followed. When α1=0.1, echo cancellation operates so as to follow the variation in echo path. Hence, setting threshold value α1 to a relatively large value increases the convergence speed but at the cost of reduced echo cancellation efficiency, resulting in the lowered resistance against double talk. It should be noted that, with both characteristics shown in both FIGS. 4(a) and 4(b) taken into consideration, the intermediate threshold value, α1=0.03, is found optimum. Now referring back to FIG. 2, the inventive apparatus 1000 is provided for canceling an echo of a first audio signal x(n) which is transmitted to a remote place, from a second audio signal y(n) which is received from the remote place and contains the echo. The second audio signal y(n) is provided under either of a double-talk state or a single-talk state. In the apparatus 1000, a first transform section 825 transforms the first audio signal x(n) of time domain into a first signal X(i) of frequency domain composed of a plurality of frequency components each having an amplitude and a phase of specific values. A multiplication section 400 multiples each frequency component of the first signal X(i) by a variable coefficient H to produce a reference signal R(i) of frequency domain. The variable coefficient H is updated by an update addition value ΔH. A second transform section 800 transforms the second audio signal y(n) of time domain into a second signal Y(i) of frequency domain composed of a plurality of frequency components each having an amplitude and a phase of specific values. A subtraction section 500 subtracts the reference signal R(i) from the second signal Y(i) to provide an error signal E(i) of frequency domain, whereby the echo contained in the second audio signal y(n) is canceled by the subtracting section 500. A computation section 210 computes the update addition value ΔH for the variable coefficient H on the basis of the error signal and the first signal. A determination section 200 determines whether the second audio signal y(n) is provided under the double-talk state or the single-talk state on the basis of the update addition value ΔH. An update section 250 and 260 updates the variable coefficient H by the update addition value ΔH when the determination section 200 determines that the second audio signal y(n) is provided under the single-talk state, and stops the updating of the variable coefficient H by the update addition value ΔH when the determination section 200 determines that the second audio signal y(n) is provided under the double-talk state.

### 2. Second Embodiment

In the above-mentioned first embodiment, the estimation of estimated transmission function Hₖ(i) is executed by conversion into the frequency domain. It is also practicable to execute the estimation by use of a signal in the time domain. In this case, the same hardware configuration as that of the first embodiment may be used. However, the algorithm configuration and operation differ from those of the first embodiment.

2.1 Algorithm Configuration

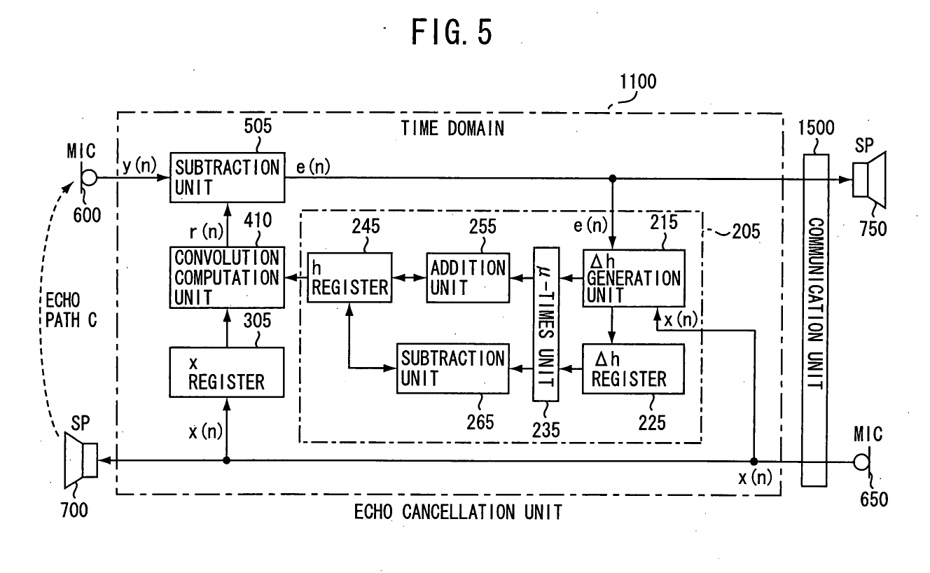

The following describes an algorithm configuration of the echo cancellation apparatus 100 in the time domain with reference to FIG. 5.

Referring to FIG. 5, a microphone 650 of the other party, a loudspeaker 750 of the other party, and a communication unit 1500 are as described before with reference to FIG. 2. Reference numeral 215 denotes a Δh generation unit for computing update addition value Δhₖ(n) which is a difference in updating estimated impulse response hₖ(n) by a learning identification method shown in equation (4) below by use of a value of error signal e(n) and a value of audio signal x(n).

$$Δ {h}_{k} ( n ) = μ \cdot \frac{e ( n ) \cdot x ( n )}{{\sum }_{n = 0}^{N - 1} {x}^{2} ( n )} \qquad ( 4 )$$

where μrepresents convergence efficiency, which is a constant within a range of 0<μ≦1 for determining the convergence speed of hₖ(n). Namely, update addition value Δhₖ(n) is obtained by multiplying error signal e(n) by audio signal x(n) and multiplying, by the convergence coefficient, a value obtained by dividing the result of the multiplication between e(n) and x(n) by a square sum of audio signal x(n).

Reference numeral 225 denotes a Δh register for temporarily storing a value computed by the Δh generation unit 215. Reference numeral 235 denotes a μ-times unit for multiplying an output value of the Δh generation unit 215 by convergence coefficient μ as required. Reference numeral 245 denotes a register for storing a value of estimated impulse response hₖ(j). Reference numeral 255 denotes an addition unit for adding an output value of the Δh generation unit 215 multiplied by μ to a value of the register 245. Reference numeral denotes a subtraction unit for subtracting an output value of the Δh register 225 multiplied by μ from a value of the register 245. Reference numeral 305 denotes an x register capable of storing N pieces of sampling data x(n). Reference numeral 410 denotes a convolution computation unit for computing reference signal r(n) by executing a convolution computation of equation (5) below.

$$r ( n ) = {h}_{k} ( n ) * x ( n ) = {\sum }_{j = 0}^{N - 1} {h}_{k} ( j ) \cdot x ( n - j ) \qquad ( 5 )$$

where “*” denotes an operator indicative of convolution and hₖ(n) denotes an estimated impulse response of echo path C. Namely, estimated impulse response Hₖ(j) is multiplied by signal x(n−j) and a sum of the multiplications is computed. It should be noted that estimated impulse response hₖ(n) converges to an approximate value of impulse response h(n) of echo path C by an update operation to be described later.

Reference numeral 505 denotes a subtraction unit for subtracting a value of reference signal r(n) from a value of audio signal y*n) picked up by the microphone 600 and sampled. It should be noted that output signal e(n) of the subtraction unit 505 is referred to as an error signal. Then, the voice based on error signal e(n) is sounded from the loudspeaker 750 of the other party through the communication unit 1500. An adaptive filter 205 is made up of the Δh generation unit 215, the Δh register 225, the μ-times unit 235, the addition unit 250, and the subtraction unit 265. An echo cancellation unit 1100 is made up of the x register 305, the convolution computation unit 410, the subtraction unit 505, and the adaptive filter 205. It should be noted that, unlike the first embodiment, not the processing of complex numbers but the processing of real numbers is executed in these registers and computation units of the second embodiment.

2.2 Operation of the Second Embodiment

2.2.1 Operation of the Echo Cancellation Unit 1100

The overall operation of the second embodiment is the same as that of the first embodiment, so that the following description will be made in the operation of the echo cancellation unit and in the operation of the adaptive filter, separately. First, the operation of the echo cancellation unit will be described with reference to FIG. 5.

If a convolution computation is executed by the convolution computation unit 410 in the single-talk state in which only the voice sounded from the loudspeaker 700 is inputted in the microphone 600 via the echo path, a pseudo echo simulating echo path C is generated. Namely, when signal x(n) is sequentially stored in the x register 305 to be updated at certain time intervals, signal y(n) to be inputted in the microphone 600 is simulated by the convolution computation according to equation (5) above. At this moment, estimated impulse response hₖ(n) is separately set by the adaptive filter 205. Value of N is a response length of impulse response h(n), which depends on the convergence time of impulse response h(n). As the convergence time gets longer, a larger value of N is required.

Next, reference signal r(n) generated by the convolution computation is subtracted by the subtraction unit 505 from audio signal y(n) picked up by the microphone 600 and then sampled. Further, so as to minimize error signal e(n) subtracted by the subtraction unit 505, estimated impulse response hₖ(n) is sequentially updated, the coefficient converging to impulse response h(n) of echo path C. Subtracted signal e(h) is sounded from the loudspeaker 750 of the other parity through the communication unit 1500.

2.2.2 Operation of the Adaptive Filter 205

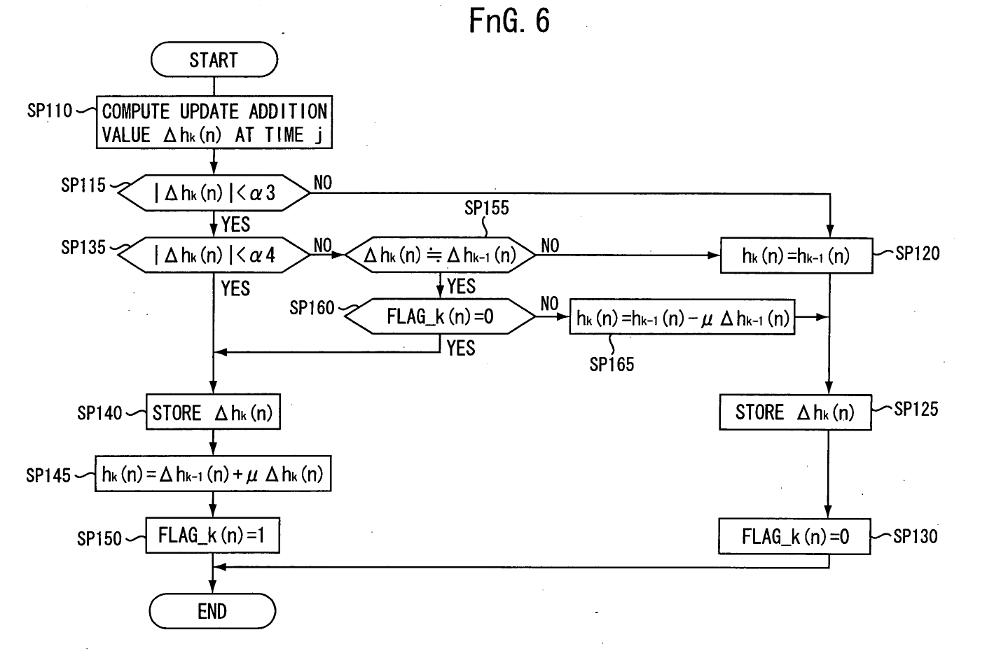

The adaptive filter 205 updates estimated pulse response hₖ(n) such that the updating of the estimated impulse response is stopped in the double-talk state and error signal e(n) is minimized in the single-talk state. Hence, a routine shown in FIG. 6 is started every time signal x(n) is inputted and the k-th convolution computation is executed.

In step SP110, update addition value Δhₖ(n) is computed on the basis of the learning identification method shown in equation (4) above. Then, the procedure goes to step SP115.

In step SP115, it is determined whether an absolute value of Δhₖ(n) is smaller than a value of α3. For α3, a value that allows the determination of the double-talk state is set as a double-talk determination threshold value. If the absolute value of Δhₖ(n) is found greater than the value of α3, then the decision is “NO”, upon which the procedure goes to step SP120. In step SP120, the value of hₖ(n) in the h register 245 is set to hₖ₋₁(n) and the estimated impulse response is not updated. The procedure goes to step SP125, in which the value of Δhₖ(n) is stored in the ΔH register 220. In step SP130, the value of flag_k(n) is set to “0”, upon this routine comes to an end. Here, flag-k(n) denotes whether estimated impulse response hₖ(n) has been updated at k-th frame, “1” denoting that the update has been made while “0” denotes that the update has not been made.

On the other hand, if the absolute value of update addition value Δhₖ(n) is found smaller than the value of α3 in step SP115, then the decision is “YES”, upon which the procedure goes to step SP135. In step SP135, it is determined whether the absolute value of update addition value Δhₖ(n) is smaller than any setting value α4. For α4, a small value that allows the determination of the single-talk state is set. If the absolute value of update addition value Δhₖ(n) is found smaller than α4, the decision is “YES”, upon which procedure goes to step SP140. In step S140, the value of Δhₖ(n) is stored in the Δh register 225, upon which the procedure goes to step SP145, in which the value of estimated impulse response hₖ(n) is updated to a value of {hₖ₋₁(n)+μΔhₖ(n)} by the μ-times unit 235 and the addition unit 255. Here, convergence coefficient μis selected to any value. In step SP150, the value flag_k(n) i set to “1”, storing the updating of the estimated impulse response hₖ(n) at the k-th frame. Then, this routine comes to an end.

If the absolute value of update addition value Δhₖ(n) is found greater than α4 in step SP135, then the decision is “NO”. In this case, one of the double-talk state and the single-talk state is possible. Then, the procedure goes to step SP155, in which it is determined whether the value of update addition value Δhₖ(n) is approximately equal to the value of last update addition value Δhₖ₋₁(n). If the value of Δhₖ₋₁(n) is found approximately equal to the value of Δhₖ(n), then the decision is “YES”, upon which the procedure goes to step SP160. The determination “approximately equal” is made by the following criterion for example:
0.9<βΔhₖ(n)/Δhₖ₋₁(n)|<1.1

In step SP160, it is determined whether flag_k−1(n)=0. If the double-talk state is on, there is almost no possibility for update addition value Δhₖ(n) to become equal to Δhₖ₋₁(n); therefore, the estimated impulse response is not updated in step SP115 or SP155. If flag_k−1=0, it indicates that an echo path variation has occurred in the single-talk state and therefore the decision is “YES”, upon which the procedure goes to step SP140, ending this routine through steps SP145 and SP150.

If flag_k−1(n)=1 in step S160, it indicates that the update was made at the last time (k−1) and therefore the decision is “NO”, upon which the procedure goes to step SP165. In step SP165, the value of {hₖ₋₁(n)−μΔhₖ₋₁(n)} is set to the value of estimated impulse response hₖ(n). Then, the procedure goes to step SP125 to end this routine through step S130.

If the value of Δhₖ(n) is significantly different from the value of Δhₖ₋₁(n) in step SP155, it indicates the double-stalk state, upon which the procedure goes to step SP120. This routines ends through steps SP125 and SP130.

As described and according to the second embodiment, whether or not the estimated impulse response is to be updated is determined depending on the size of the update addition value, so that the determination of double talk can be made regardless of how adaptation goes and the convergence can be made quickly, as compared with a technique in which the determination of double talk is made depending on error signal e (n) power or residual power. In addition, the second embodiment determines whether or not to update the estimated impulse response on the basis of not only the size of update addition value but also the variation in update addition value, so that the correct determination can be executed.

Now referring back to FIG. 5, the inventive apparatus 1100 is designed for canceling an echo of a first audio signal x(n) which is transmitted to a remote place, from a second audio signal y(n) which is received from the remote place and contains the echo. The second audio signal y(n) is provided under either of a double-talk state or a single-talk state, In the inventive apparatus 1100, a storage section 305 stores the first audio signal x(n). A convolution section 410 convolutes the stored first audio signal x(n) with a variable coefficient h to produce a reference signal r(n). The variable coefficient h is updated by an update addition value Δh. A subtraction section 505 subtracts the reference signal r(n) from the second audio signal y(n) to provide an error signal e(n), whereby the echo is canceled from the second audio signal y(n). A computation section 215 computes the update addition value Δh for the variable coefficient h on the basis of the error signal e(n) and the first audio signal x(n). A determination section 205 determines whether the second audio signal y(n) is provided under the double-talk state or the single-talk state on the basis of the update addition value Δh. An update section 255 and 265 updates the variable coefficient h by the update addition value Δh when the determination section 205 determines that the second audio signal y(n) is provided under the single-talk state, and stops the updating of the variable coefficient h by the update addition value Δh when the determination section determines that the second audio signal y(n) is provided under the double-talk state.

3. Variations

The present invention is not restricted only to the above-mentioned embodiments. For example, variations that follow are also practicable, which are included in the scope of the present invention.

(1) In the above-mentioned embodiments, the update addition values are computed by use of the learning identification method. It is also practicable to use another algorithm such as LMS (Least Mean Square) algorithm.

(2) In steps SP15 and SP35 in the above-mentioned embodiment, the double-talk state is determined by making comparison between the absolute values of update addition values ΔHₖ(i) for all discrete frequencies i and α1 or α2. However, the determination of the double-talk state need not always use update addition values ΔHₖ(i) for all discrete frequency i. Therefore, it is also practicable to determine the double-talk state depending on the satisfaction of a predetermined condition by a predetermined number of update addition values ΔHₖ(i).

For example, al and al are determined for each discrete frequency i and if a predetermined number of ΔHₖ(i) satisfying “ΔHₖ(i)<α1(i) (or α2(i))” is detected, “YES” may be determined in step SP15 (or SP35). In this case, α1(i) or α2(i) may be different for each discrete frequency i. For example, because a low frequency component is easily affected by the variation in space, a smaller α1(i) may be set as the frequency goes lower.

(3) In the above-mentioned embodiment, the echo cancellation is executed by a program stored in the ROM 70. It is also practicable to store this program in CD-ROMs, flexible disks, or other storage media to be distributed to users or distribute this program through communication lines.

1. A method of processing a first audio signal at transmission and a second audio signal upon receipt so as to determine whether the second audio signal is provided under a double-talk state or a single-talk state, the method comprising:
a first transform step of transforming the first audio signal of time domain into a first signal of frequency domain composed of a plurality of frequency components each having an amplitude and a phase of specific values;
a multiplication step of multiplying each frequency component of the first signal by a variable coefficient to produce a reference signal of frequency domain, the variable coefficient being updated by an update addition value;
a second transform step of transforming the second audio signal of time domain into a second signal of frequency domain composed of a plurality of frequency components each having an amplitude and a phase of specific values;
a subtraction step of subtracting the reference signal from the second signal to provide an error signal of frequency domain;
a computation step of computing the update addition value for the variable coefficient on the basis of the error signal and the first signal; and
a determination step of determining whether the second audio signal is provided under the double-talk state or the single-talk state on the basis of the update addition value.

2. The method according to claim 1, wherein the determination step compares the update addition value with a predetermined upper critical value and determines that the second audio signal is provided under the double-talk state when the update addition value exceeds the predetermined upper critical value.

3. The method according to claim 1, wherein the determination step compares the update addition value with a predetermined lower critical value and determines that the second audio signal is provided under the single-talk state when the update addition value is lower than the predetermined lower critical value.

4. The method according to claim 1, wherein the determination step compares a current update addition value with a previous update addition value and determines that the second audio signal is currently provided under the double-talk state when a difference between the current update addition value and the previous update addition value is greater than a predetermined threshold value.

5. The method according to claim 4, wherein the determination step determines that the second audio signal is currently provided under the single-talk state when the difference between the current update addition value and the previous update addition value is smaller than the predetermined threshold value and when the variable coefficient has not been updated by the previous update addition value.

6. A method of processing a first audio signal at transmission and a second audio signal upon receipt so as to determine whether the second audio signal is provided under a double-talk state or a single-talk state, the method comprising:
a storage step of storing the first audio signal;
a convolution step of convoluting the stored first audio signal with a variable coefficient to produce a reference signal, the variable coefficient being updated by an update addition value;
a subtraction step of subtracting the reference signal from the second audio signal to provide an error signal;
a computation step of computing the update addition value for the variable coefficient on the basis of the error signal and the first audio signal; and
a determination step of determining whether the second audio signal is provided under the double-talk state or the single-talk state on the basis of the update addition value.

7. The method according to claim 6, wherein the determination step compares the update addition value with a predetermined upper critical value and determines that the second audio signal is provided under the double-talk state when the update addition value exceeds the predetermined upper critical value.

8. The method according to claim 6, wherein the determination step compares the update addition value with a predetermined lower critical value and determines that the second audio signal is provided under the single-talk state when the update addition value is lower than the predetermined lower critical value.

9. The method according to claim 6, wherein the determination step compares a current update addition value with a previous update addition value and determines that the second audio signal is currently provided under the double-talk state when a difference between the current update addition value and the previous update addition value is greater than a predetermined threshold value.

10. The method according to claim 9, wherein the determination step determines that the second audio signal is currently provided under the single-talk state when the difference between the current update addition value and the previous update addition value is smaller than the predetermined threshold value and when the variable coefficient has not been updated by the previous update addition value.

11. A method of canceling an echo of a first audio signal which is transmitted to a remote place, from a second audio signal which is received from the remote place and contains the echo, the second audio signal being provided under either of a double-talk state or a single-talk state, the method comprising:
a first transform step of transforming the first audio signal of time domain into a first signal of frequency domain composed of a plurality of frequency components each having an amplitude and a phase of specific values;
a multiplication step of multiplying each frequency component of the first signal by a variable coefficient to produce a reference signal of frequency domain, the variable coefficient being updated by an update addition value;
a second transform step of transforming the second audio signal of time domain into a second signal of frequency domain composed of a plurality of frequency components each having an amplitude and a phase of specific values;
a subtraction step of subtracting the reference signal from the second signal to provide an error signal of frequency domain, whereby the echo contained in the second audio signal can be canceled by the subtracting step;
a computation step of computing the update addition value for the variable coefficient on the basis of the error signal and the first signal;
a determination step of determining whether the second audio signal is provided under the double-talk state or the single-talk state on the basis of the update addition value; and
an update step of updating the variable coefficient by the update addition value when the determination step determines that the second audio signal is provided under the single-talk state, and stopping the updating of the variable coefficient by the update addition value when the determination step determines that the second audio signal is provided under the double-talk state.

12. A method of canceling an echo of a first audio signal which is transmitted to a remote place, from a second audio signal which is received from the remote place and contains the echo, the second audio signal being provided under either of a double-talk state or a single-talk state, the method comprising:
a storage step of storing the first audio signal;
a convolution step of convoluting the stored first audio signal with a variable coefficient to produce a reference signal, the variable coefficient being updated by an update addition value;
a subtraction step of subtracting the reference signal from the second audio signal to provide an error signal, whereby the echo can be canceled from the second audio signal;
a computation step of computing the update addition value for the variable coefficient on the basis of the error signal and the first audio signal;
a determination step of determining whether the second audio signal is provided under the double-talk state or the single-talk state on the basis of the update addition value; and
an update step of updating the variable coefficient by the update addition value when the determination step determines that the second audio signal is provided under the single-talk state, and stopping the updating of the variable coefficient by the update addition value when the determination step determines that the second audio signal is provided under the double-talk state.

13. An apparatus for processing a first audio signal at transmission and a second audio signal upon receipt so as to determine whether the second audio signal is provided under a double-talk state or a single-talk state, the apparatus comprising:
a first transform section that transforms the first audio signal of time domain into a first signal of frequency domain composed of a plurality of frequency components each having an amplitude and a phase of specific values;
a multiplication section that multiplies each frequency component of the first signal by a variable coefficient to produce a reference signal of frequency domain, the variable coefficient being updated by an update addition value;
a second transform section that transforms the second audio signal of time domain into a second signal of frequency domain composed of a plurality of frequency components each having an amplitude and a phase of specific values;
a subtraction section that subtracts the reference signal from the second signal to provide an error signal of frequency domain;
a computation section that computes the update addition value for the variable coefficient on the basis of the error signal and the first signal; and
a determination section that determines whether the second audio signal is provided under the double-talk state or the single-talk state on the basis of the update addition value.

14. An apparatus for processing a first audio signal at transmission and a second audio signal upon receipt so as to determine whether the second audio signal is provided under a double-talk state or a single-talk state, the apparatus comprising:
a storage section that stores the first audio signal;
a convolution section that convolutes the stored first audio signal with a variable coefficient to produce a reference signal, the variable coefficient being updated by an update addition value;
a subtraction section that subtracts the reference signal from the second audio signal to provide an error signal;
a computation section that computes the update addition value for the variable coefficient on the basis of the error signal and the first audio signal; and
a determination section that determines whether the second audio signal is provided under the double-talk state or the single-talk state on the basis of the update addition value.

15. An apparatus for canceling an echo of a first audio signal which is transmitted to a remote place, from a second audio signal which is received from the remote place and contains the echo, the second audio signal being provided under either of a double-talk state or a single-talk state, the apparatus comprising:
a first transform section that transforms the first audio signal of time domain into a first signal of frequency domain composed of a plurality of frequency components each having an amplitude and a phase of specific values;
a multiplication section that multiples each frequency component of the first signal by a variable coefficient to produce a reference signal of frequency domain, the variable coefficient being updated by an update addition value;
a second transform section that transforms the second audio signal of time domain into a second signal of frequency domain composed of a plurality of frequency components each having an amplitude and a phase of specific values;
a subtraction section that subtracts the reference signal from the second signal to provide an error signal of frequency domain, whereby the echo contained in the second audio signal is canceled by the subtracting section;
a computation section that computes the update addition value for the variable coefficient on the basis of the error signal and the first signal;
a determination section that determines whether the second audio signal is provided under the double-talk state or the single-talk state on the basis of the update addition value; and
an update section that updates the variable coefficient by the update addition value when the determination section determines that the second audio signal is provided under the single-talk state, and stops the updating of the variable coefficient by the update addition value when the determination section determines that the second audio signal is provided under the double-talk state.

16. An apparatus for canceling an echo of a first audio signal which is transmitted to a remote place, from a second audio signal which is received from the remote place and contains the echo, the second audio signal being provided under either of a double-talk state or a single-talk state, the apparatus comprising:
a storage section that stores the first audio signal;
a convolution section that convolutes the stored first audio signal with a variable coefficient to produce a reference signal, the variable coefficient being updated by an update addition value;
a subtraction section that subtracts the reference signal from the second audio signal to provide an error signal, whereby the echo is canceled from the second audio signal;
a computation section that computes the update addition value for the variable coefficient on the basis of the error signal and the first audio signal;
a determination section that determines whether the second audio signal is provided under the double-talk state or the single-talk state on the basis of the update addition value; and
an update section that updates the variable coefficient by the update addition value when the determination section determines that the second audio signal is provided under the single-talk state, and stops the updating of the variable coefficient by the update addition value when the determination section determines that the second audio signal is provided under the double-talk state.

17. A program executable by a computer for performing a method of processing a first audio signal at transmission and a second audio signal upon receipt so as to determine whether the second audio signal is provided under a double-talk state or a single-talk state, wherein the method comprises:
a first transform step of transforming the first audio signal of time domain into a first signal of frequency domain composed of a plurality of frequency components each having an amplitude and a phase of specific values;
a multiplication step of multiplying each frequency component of the first signal by a variable coefficient to produce a reference signal of frequency domain, the variable coefficient being updated by an update addition value;
a second transform step of transforming the second audio signal of time domain into a second signal of frequency domain composed of a plurality of frequency components each having an amplitude and a phase of specific values;
a subtraction step of subtracting the reference signal from the second signal to provide an error signal of frequency domain;
a computation step of computing the update addition value for the variable coefficient on the basis of the error signal and the first signal; and
a determination step of determining whether the second audio signal is provided under the double-talk state or the single-talk state on the basis of the update addition value.

18. A program executable by a computer for performing a method of processing a first audio signal at transmission and a second audio signal upon receipt so as to determine whether the second audio signal is provided under a double-talk state or a single-talk state, wherein the method comprises:
a storage step of storing the first audio signal;
a convolution step of convoluting the stored first audio signal with a variable coefficient to produce a reference signal, the variable coefficient being updated by an update addition value;
a subtraction step of subtracting the reference signal from the second audio signal to provide an error signal;
a computation step of computing the update addition value for the variable coefficient on the basis of the error signal and the first audio signal; and
a determination step of determining whether the second audio signal is provided under the double-talk state or the single-talk state on the basis of the update addition value.

19. A program executable by a computer for performing a method of canceling an echo of a first audio signal which is transmitted to a remote place, from a second audio signal which is received from the remote place and contains the echo, the second audio signal being provided under either of a double-talk state or a single-talk state, wherein the method comprises:
a first transform step of transforming the first audio signal of time domain into a first signal of frequency domain composed of a plurality of frequency components each having an amplitude and a phase of specific values;
a multiplication step of multiplying each frequency component of the first signal by a variable coefficient to produce a reference signal of frequency domain, the variable coefficient being updated by an update addition value;
a second transform step of transforming the second audio signal of time domain into a second signal of frequency domain composed of a plurality of frequency components each having an amplitude and a phase of specific values;
a subtraction step of subtracting the reference signal from the second signal to provide an error signal of frequency domain, whereby the echo contained in the second audio signal can be canceled by the subtracting step;
a computation step of computing the update addition value for the variable coefficient on the basis of the error signal and the first signal;
a determination step of determining whether the second audio signal is provided under the double-talk state or the single-talk state on the basis of the update addition value; and
an update step of updating the variable coefficient by the update addition value when the determination step determines that the second audio signal is provided under the single-talk state, and stopping the updating of the variable coefficient by the update addition value when the determination step determines that the second audio signal is provided under the double-talk state.

20. A program executable by a computer for performing a method of canceling an echo of a first audio signal which is transmitted to a remote place, from a second audio signal which is received from the remote place and contains the echo, the second audio signal being provided under either of a double-talk state or a single-talk state, wherein the method comprises:
a storage step of storing the first audio signal;
a convolution step of convoluting the stored first audio signal with a variable coefficient to produce a reference signal, the variable coefficient being updated by an update addition value;
a subtraction step of subtracting the reference signal from the second audio signal to provide an error signal, whereby the echo can be canceled from the second audio signal;
a computation step of computing the update addition value for the variable coefficient on the basis of the error signal and the first audio signal;
a determination step of determining whether the second audio signal is provided under the double-talk state or the single-talk state on the basis of the update addition value; and
an update step of updating the variable coefficient by the update addition value when the determination step determines that the second audio signal is provided under the single-talk state, and stopping the updating of the variable coefficient by the update addition value when the determination step determines that the second audio signal is provided under the double-talk state.
